(19) United States
(12) Patent Application Publication
(10) Pub. No.: US 2025/0328502 A1
(43) Pub. Date: Oct. 23, 2025

(54) FILE MANAGEMENT SYSTEM AND FILE MANAGEMENT METHOD

(71) Applicant: Hitachi, Ltd., Tokyo (JP)

(72) Inventors: Sungho Kim, Tokyo (JP); Yusaku Otsuka, Tokyo (JP); Yasushi Nishiyama, Tokyo (JP); Hiroaki Watahiki, Tokyo (JP); Shinichi Tsunoo, Tokyo (JP)

(21) Appl. No.: 19/083,824

(22) Filed: Mar. 19, 2025

(30) Foreign Application Priority Data
Apr. 23, 2024 (JP) 2024-070033

(51) Int. Cl. G06F 16/185; G06F 16/11; G06F 16/16; G06F 16/18

(52) U.S. Cl. CPC G06F 16/185; G06F 16/119; G06F 16/168; G06F 16/1873

(57) ABSTRACT

A file management system that manages a file system in which a user interface is constituted, an application environment is constituted, and a middle layer is constituted includes: an application image management unit that manages an application image; a middle image management unit that manages a middle image for each version; and a file system configuration management unit that performs compatibility processing for using the middle image selected from the middle image management unit in the application environment, and places the middle image subjected to the compatibility processing in the application environment to make the middle image usable in the user interface.

### CROSS-REFERENCE TO RELATED APPLICATIONS

The present application claims priority to Japanese Patent Application No. 2024-070033, filed on Apr. 23, 2024, the disclosure of which being incorporated herein by reference in its entirety.

### BACKGROUND OF THE INVENTION

### 1. Field of the Invention

The present invention relates to a file management system and a file management method.

### 2. Description of the Related Art

In recent years, the amount of work required for rebuilding an application environment in which an application is executed has increased when a control system is updated due to a version upgrade or the like. Rebuilding targets also include application data such as setting of control tags used in the application. There are a large number of pieces of application data, and there is also a wide variety of setting work. Therefore, there is demand for being able to easily update control systems.

JP 2010-79678 A discloses that “a controller includes a connection confirmation unit that confirms whether connection between a first storage system and a second storage system is possible, a switching possibility determination unit that determines whether switching from the first storage system to the second storage system is possible, a takeover information migration unit that migrates takeover information possessed by the first storage system to the second storage system, a user data migration unit that migrates user data stored in a first user region to the second storage system, and a switching execution unit that allows the receipt of I/O from a host in the second storage system”.

### SUMMARY OF THE INVENTION

In addition, it is necessary to rebuild the application environment also when the version of a middle image is upgraded in association with changes of hardware or an operating system (OS) used in the control system or a function provided by the middle image is changed. As described later, a set of a plurality of files used in a middle layer is referred to as a “middle image”. In the rebuilding of the application environment, an operator resets millions of control tags, and the work to set such a large number of control tags takes time and effort.

The technique disclosed in JP 2010-79678 A is to control the switching of the storage system, but even with the use of this technique, it is not possible to reduce the time and effort for the work to switch the storage system.

The present invention is contrived in view of such a situation, and an object thereof is to reduce the work accompanying a change in functions of a control system.

A file management system according to the present invention manages a file system in which a user interface that is operated by an application of a control system is constituted, an application environment in which files operated through the user interface are managed is constituted, and a middle layer in which some of the files used in the application environment are managed for each version of the control system is constituted. The file management system includes: an application image management unit that manages an application image that is a set of the files used in the application; a middle image management unit that manages a middle image that is a set of some of the files managed in the middle layer for each version; and a file system configuration management unit that performs compatibility processing for using the middle image selected from the middle image management unit in the application environment, and places the middle image subjected to the compatibility processing in the application environment to make the middle image usable in the user interface.

According to the present invention, it is possible to reduce the work accompanying a change in functions of a control system.

Problems, configurations, and effects other than those described above will be clarified by the following description of embodiments.

### BRIEF DESCRIPTION OF THE DRAWINGS

FIG. 1 is a diagram showing an example of a software stack managed by a file management system according to one embodiment of the present invention;

FIG. 2 is a block diagram showing an overall configuration example of the file management system according to one embodiment of the present invention;

FIG. 3 is a schematic diagram showing an outline of operation examples of functional units by the file management system according to one embodiment of the present invention, and an example of a software stack;

FIG. 4 is a diagram showing operation examples of a middle image management unit and an application image management unit according to one embodiment of the present invention;

FIG. 5 is a diagram showing a processing example of the middle image management unit according to one embodiment of the present invention and a software stack of files;

FIG. 6 is a diagram showing an example of a final image after processing by the application image management unit according to one embodiment of the present invention;

FIG. 7 is a flowchart showing an example of basic processing performed by functional units of a file system configuration management unit when a control system according to one embodiment of the present invention is started up;

FIG. 8 is a diagram showing an example of a software stack when the control system according to one embodiment of the present invention is started up;

FIG. 9 is a flowchart showing an example of processing of a middle version selection unit and a compatibility necessity determination unit in compatibility processing of setting of a config file according to one embodiment of the present invention;

FIG. 10 is a diagram showing an example of a software stack in compatibility processing of the setting content of a config file according to one embodiment of the present invention;

FIG. 11 is a flowchart showing an example of compatibility processing of a config file performed by a compatibility processing unit according to one embodiment of the present invention;

FIG. 12 is a diagram showing an example of a software stack in the compatibility processing of the config file according to one embodiment of the present invention;

FIG. 13 is a flowchart showing an example of function extension compatibility processing performed by the file system configuration management unit according to one embodiment of the present invention;

FIG. 14 is a diagram showing an example of a software stack in DLL compatibility processing according to one embodiment of the present invention;

FIG. 15 is a schematic diagram showing an outline of operation examples of the functional units by the file management system in the installation and the operation of a new application according to one embodiment of the present invention, and an example of a software stack; and

FIG. 16 is a block diagram showing a hardware configuration example of a computing machine according to one embodiment of the present invention.

### DESCRIPTION OF THE PREFERRED EMBODIMENTS

Hereinafter, embodiments of the present invention will be described with reference to the accompanying drawings. In the present specification and drawings, components having substantially the same function or configuration will be denoted by the same reference numerals, and redundant description will be omitted.

### One Embodiment

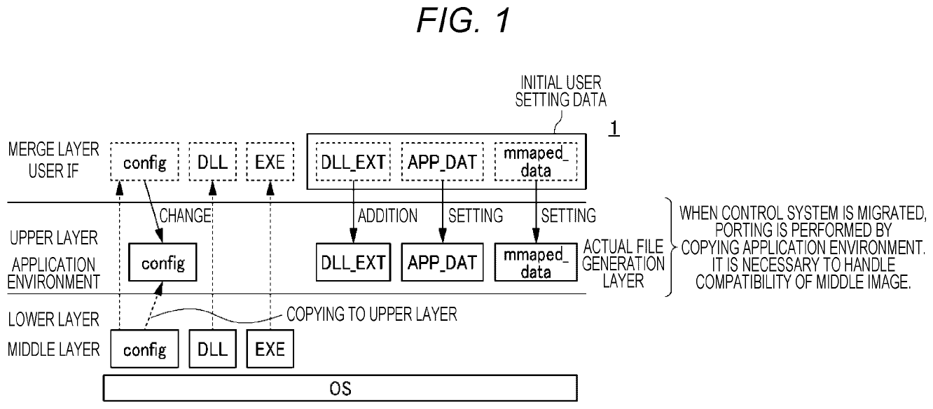

First, an outline of processing that is performed in a file management system according to one embodiment of the present invention will be described with reference to FIG. 1.

FIG. 1 is a diagram showing an example of a software stack managed by a file management system 1 according to one embodiment. In the following description, a set of a plurality of files is referred to as an “image”. In the upper part of FIG. 1, a configuration example of a file in an application environment of an upper layer is shown.

The file management system 1 manages a file system including, from the top in FIG. 1, a merge layer, an upper layer, a lower layer, and an OS. In the merge layer, a user interface (abbreviated as “user IF”) that is operated by an application of a control system is constituted. A user can operate a file through the user IF. In the upper layer, an application environment in which files that are operated through the user IF are managed is constituted. In the lower layer, a middle layer in which some of the files used in the application environment are managed for each version of the control system is constituted. A set of a plurality of files used in the application environment is referred to as an “application image”.

In the merge layer, files existing in the upper layer and the lower layer are merged without overlapping and displayed through the user IF. For example, config, DLL, and EXE files are not in the merge layer, and the files in the upper layer or the lower layer can be accessed through the user IF. The user can operate the files in the upper layer and the lower layer by an operation in the merge layer through the user IF displayed on the screen by operating a PC or the like. The user IF can ensure compatibility between the processing operation of the middle layer and the application environment used in the control system as a migration source and the processing operation of the middle layer and the application environment used in the control system as a migration destination.

When the user performs an operation of changing a file seen from the user IF, the file that is a target to be operated is copied from the lower layer to the upper layer. The setting content set in the file by the file operation of the user is reflected in the file copied to the upper layer. For example, a config file in the lower layer is displayed as it is in the user IF. The config file is a file group that is used for the control of the middle operation set by the user, and is used as an example of a setting file. When the user performs a change operation on the config file from the user IF, the config file in the lower layer is copied to the upper layer. Therefore, the setting content is reflected in the config file copied to the upper layer.

Meanwhile, a dynamic link library (DLL) file and an EXE file in the lower layer are not copied to the upper layer since they are not changed. However, the DLL file and the EXE file are seen in the user IF. The DLL is a file that is used for extending a function provided by a middle image. The EXE is a file including instructions and data necessary for the execution of a program in a binary format, and is used as an example of an execution file.

In addition, the user can also add or set initial user setting data in the application environment. It is assumed that, as the initial user setting data, for example, DLL_EXT, APP_DAT, and mmaped_data files are installed in the control system through the user IF. The DLL_EXT file is a file that is added to the application environment. The APP_DAT and mmaped_data are files that are set in the application environment, and include the above-described control tags. As described above, the upper layer in which the application environment is constituted is also used as an actual file generation layer in which an actual file is generated. The user can operate the DLL_EXT, APP_DAT, and mmaped_data files that are in the merge layer through the user IF.

As shown on the right side of FIG. 1, when the control system is migrated, the files existing in the application environment and changed in the application environment are ported by copying from the control system as a migration source to the control system as a migration destination. For example, when the version of a middle image is upgraded in association with changes of hardware or an OS used in the control system or a function provided by the middle image is changed, it is necessary to handle compatibility of the middle image present in the upper layer. The compatibility handling includes selection of a middle version, determination of whether compatibility is necessary, and compatibility processing, which will be described later. The compatibility handling performed in the file management system 1 will be described below.

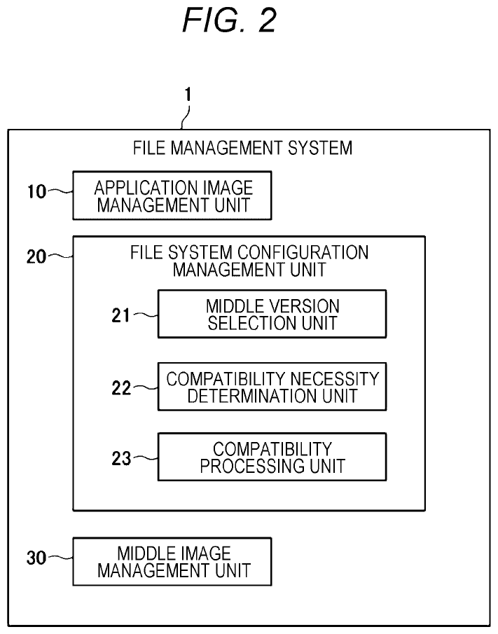

FIG. 2 is a block diagram showing an overall configuration example of the file management system 1 according to the present embodiment.

The file management system 1 includes an application image management unit 10, a file system configuration management unit 20, and a middle image management unit 30.

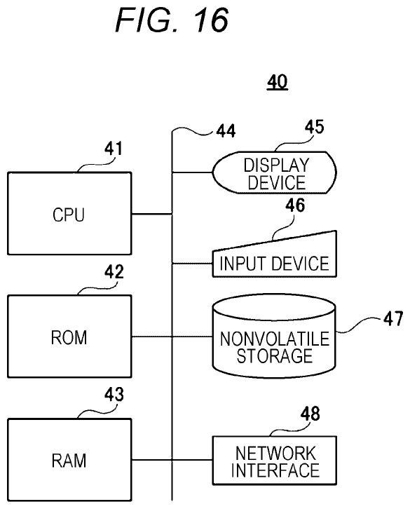

The application image management unit 10 manages an application image. The application image is a set of a plurality of files in the application environment built in the upper layer shown in FIG. 1. The application image management unit 10 has a function of executing a middle image (for example, an EXE file in a binary format) loaded from a designated mounting point into a memory (RAM 43 to be described later shown in FIG. 16).

In addition, the application image management unit 10 loads the middle image from the designated mounting point and copies an application data file in the lower layer. The application image management unit 10 has a function of building an application environment in the upper layer on the basis of the application data file, and displaying the application data file operably on a conventional user IF. In addition, the application image management unit 10 has a function of securing Config/API compatibility by intervention processing of the file system configuration management unit 20 to be described later when processing for control system start-up is started. The application image management unit 10 manages a file group collected from the application environment as an application data file.

The file system configuration management unit 20 organizes the software stack constituting the file system in a hierarchical structure, and manages the lower layer and the upper layer, that is, the middle layer and the application environment separately. The file system configuration management unit 20 performs compatibility processing for using a middle image selected from the middle image management unit 30 in the application environment, and places the middle image subjected to the compatibility processing in the application environment to make the middle image usable in the user IF. Therefore, the file system configuration management unit 20 determines whether the compatibility processing is necessary for the middle image of a version selected from the middle image management unit 30, performs the compatibility processing on the middle image for which the compatibility processing is determined to be necessary, and causes the application image management unit 10 to use the middle image subjected to the compatibility processing.

In addition, the file system configuration management unit 20 manages the application environment including application data generated by the work in the upper layer. When the version of the middle image is upgraded, the application environment managed by the file system configuration management unit 20 can be easily migrated to the application environment of a new control system. In addition, the file system configuration management unit 20 can ensure the operation compatibility of the new version of the middle image in the application environment of the migration destination. In addition, the file system configuration management unit 20 can perform, for the middle image requiring the compatibility processing, the determination of whether the compatibility processing is necessary and the execution of the compatibility processing after the file management system 1 starts the processing from the user IF.

The file system configuration management unit 20 includes a middle version selection unit 21, a compatibility necessity determination unit 22, and a compatibility processing unit 23.

The middle version selection unit 21 selects the middle image to be searched for from the middle image management unit 30 in order of the latest version in the middle layer. The middle image to be searched for from the middle image management unit 30 includes, for example, a file that is operated through the user IF.

The compatibility necessity determination unit 22 determines whether the compatibility processing is necessary for the middle image selected by the middle version selection unit 21. Therefore, the compatibility necessity determination unit 22 determines whether compatibility is necessary between the application and the middle image.

The compatibility processing unit 23 performs the compatibility processing on the middle image for which the compatibility processing is determined to be necessary.

In the following description, an old version of the middle image used in the control system before the hardware or OS is changed, that is, before migration may be referred to as an “old middle image”, and may be written as “old middle” in the drawings. Further, a new version of the middle image used in the control system after the hardware or OS is changed, that is, after migration may be referred to as a “new middle image”, and may be written as “new middle” in the drawings.

The middle image management unit 30 manages the middle images according to the use of the application for each middle version in the middle layer, and provides the middle image selected by the middle version selection unit 21. Managing one or more versions of middle images for each middle version in a hierarchical structure by the middle image management unit 30 is referred to as a “multi-version”. For example, the middle image management unit 30 manages the middle images in the multi-version in a transition period during which the control system is migrated. Therefore, the middle image management unit 30 constitutes a new version of the middle image in an upper-level layer different from the layer of the old middle image, and uses both the old middle image and the new middle image at the beginning when the control system as a migration destination is operated. When the operation of the control system after migration is stabilized, the middle image management unit 30 deletes the old middle image and manages only the new middle image.

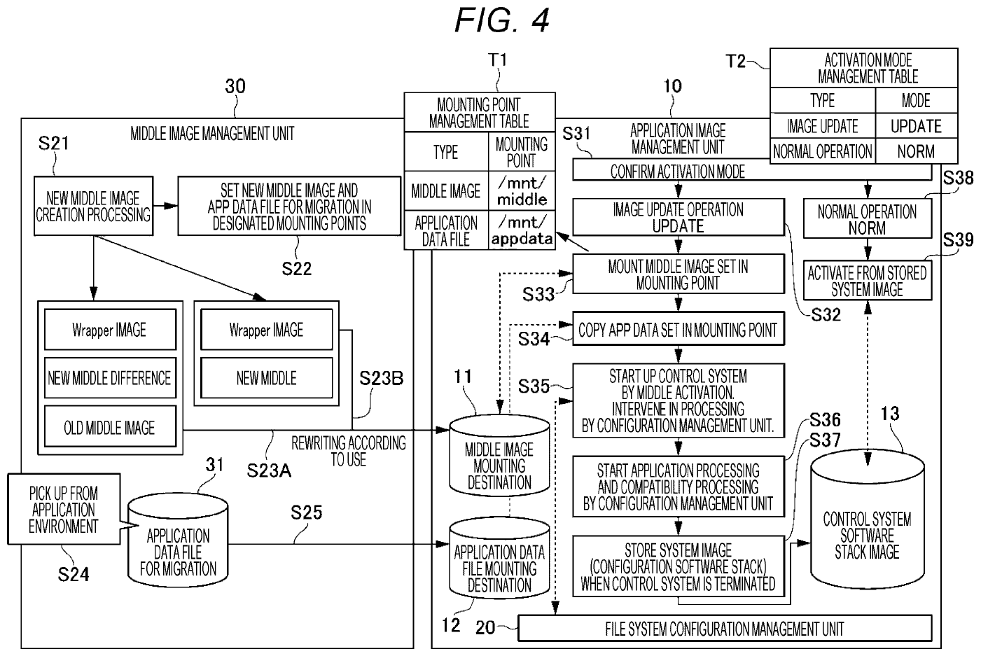

In addition, when the specifications of the control system are changed, or the functions of the control system are extended or changed, the middle image management unit 30 constitutes the file format of a new version of the config file, and constitutes middle images of new versions of the DLL file and the EXE file. In addition, when the application programming interface (API) of the new version of the DLL is changed, the middle image management unit 30 automatically generates a wrapper image for old version compatibility. The wrapper image is an example of a comprehensive file including a plurality of wrapper files. In addition, the middle image management unit 30 sets a middle image according to the operating mode in a middle image mounting destination 11 to be described later shown in FIG. 4 in regard to a designated mounting point in a computing machine in which the application environment is operated.

### Solution to Problem of Ensuring Compatibility

In the control system switching, it is necessary to secure the operation compatibility of files related to the functions between the application environment and the middle layer. First, the operation compatibility of files will be described.

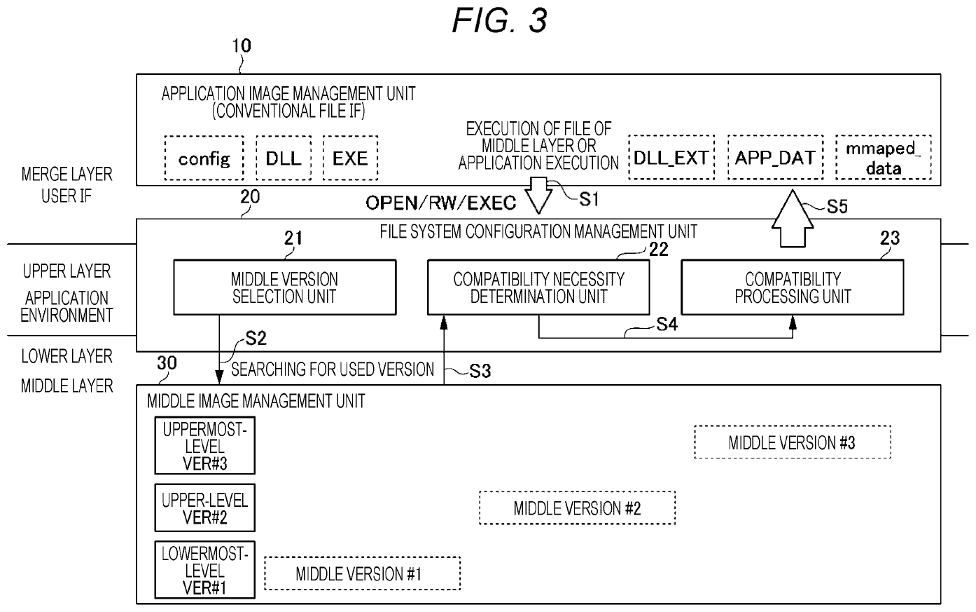

FIG. 3 is a schematic diagram showing an outline of operation examples of functional units by the file management system 1, and an example of a software stack.

The application image management unit 10 provides a conventional user IF to the user. The user can operate the config, DLL, EXE, DLL_EXT, APP_DAT, and mmaped_data files through the conventional user IF, and confirm the result of the operation. First, attention is paid to the config file and DLL.

In order to maintain the compatibility of the user IF with respect to the operation in the files of the old middle layer in the control system before migration, it is necessary to perform an operation in a new middle layer of the control system after migration while maintaining the user IF between the setting file created in the old middle layer and each DLL. Therefore, the middle image management unit 30 manages the middle images by adopting a multi-version configuration for the lower layer and providing a hierarchical structure for each version. The versions in the lower layer are identified by layers. Then, the file management system 1 secures the operation compatibility of files used in the application environment.

FIG. 3 shows an example of middle images of middle versions divided into three layers. In a lowermost-level layer VER #1, a middle image of a middle version #1 is present. Similarly, a middle image of a middle version #2 is present in an upper-level layer VER #2, and a middle image of a middle version #3 is present in an uppermost-level layer VER #3. The middle image of the middle version #1 is the oldest, and as the number increases, it indicates a newer middle version. Therefore, the middle image of the middle version #3 is the latest.

When the user performs an operation through the user IF, the application image management unit 10 executes a file of the middle layer or executes the application (S1). In this processing, for example, file opening (OPEN), reading and writing (RW), and execution (EXEC) are performed.

The middle version selection unit 21 searches for the middle version of the middle image to which an operation instruction has been output by the application image management unit 10 (S2). Therefore, the middle version selection unit 21 accesses the middle image management unit 30, and searches for the version of the middle image to be used in the user IF.

The middle version selection unit 21 sends the middle image searched from the middle image management unit 30 to the compatibility necessity determination unit 22 (S3). The compatibility necessity determination unit 22 determines whether compatibility is necessary between the application and the middle version of the middle image, and outputs the determination result to the compatibility processing unit 23 (S33).

The compatibility processing unit 23 performs the compatibility processing on the middle image for which the compatibility processing is determined to be necessary. The middle image subjected to the compatibility processing can be used in the application image management unit 10 (S5). The functional units shown in the file system configuration management unit 20 are illustrated as being in the upper layer in FIG. 3. However, the file system configuration management unit 20 represents mediating processing between the application image management unit 10 and the middle image management unit 30, and is not actually constituted in the upper layer.

FIG. 4 is a diagram showing operation examples of the middle image management unit 30 and the application image management unit 10.

First, an operation example of the middle image management unit 30 shown on the left side of FIG. 4 will be described.

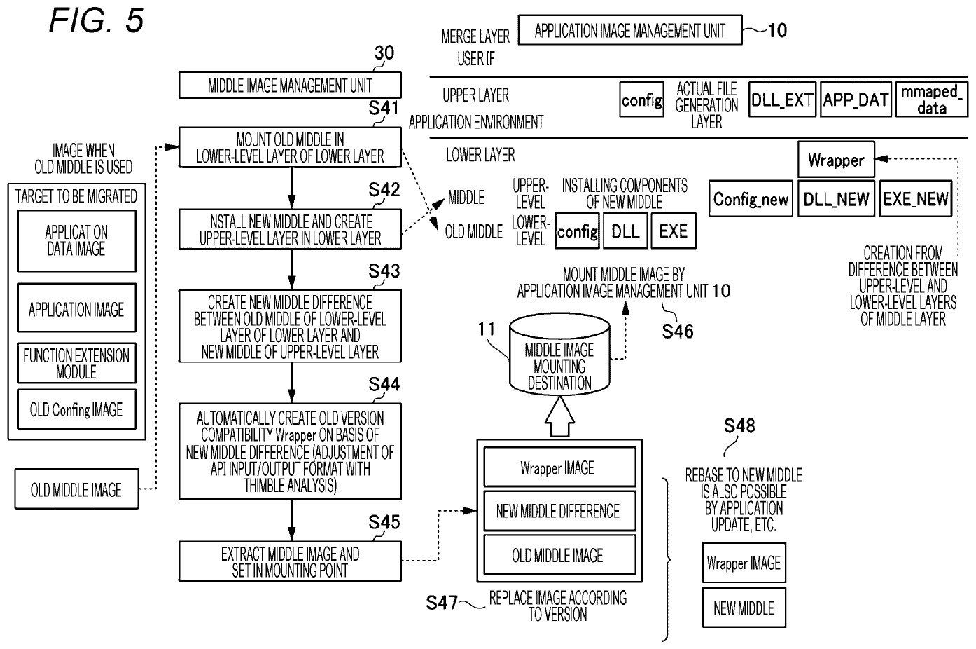

In the middle image management unit 30, when processing of creating a new middle image to be described later shown in FIG. 5 is performed (S21), an old middle image, a new middle difference, and a wrapper image are created. The new middle difference includes data of a difference between the old middle image and the new middle image.

Next, the middle image management unit 30 sets the new middle image and an application data file 31 for migration in designated mounting points, respectively, on the basis of a mounting point management table T1 (S22).

The mounting point management table T1 is a table that has items: type; and mounting point, and is shared by the middle image management unit 30 and the application image management unit 10. In the type item, a middle image indicating the type of the file to be mounted, or an application data file is stored. In the mounting point item, a mounting point, which is information on a mounting destination of each file, is recorded. For example, regarding the middle images and application data files, paths of the images and files are stored in the mounting point item as information indicating the mounting destination.

The middle image management unit 30 mounts the old middle image, new middle difference, and wrapper image on the middle image mounting destination 11 managed by the application image management unit 10 with reference to the mounting point management table T1 (S23A). Due to the mounted old middle image, when the middle image subjected to the compatibility processing has a defect, the file system configuration management unit 20 can acquire the old version of the middle image and perform rollback allowing using in the application image management unit 10.

However, the old middle image has a large data size. After a new file management system 1 is stably operated, the old middle image becomes unnecessary. Therefore, when the old middle image becomes unnecessary, only the new middle image and wrapper image may be mounted in the middle image mounting destination 11 (S23B). In this manner, the middle image mounted in the middle image mounting destination 11 is rewritten according to the use of the middle image.

In addition, the middle image management unit 30 picks up the application data file 31 for migration from the application environment of the upper layer (S24). Then, the middle image management unit 30 mounts the application data file 31 for migration in an application data file mounting destination 12 with reference to the mounting point management table T1 (S25). The application data file 31 for migration includes, for example, the config, DLL_EXT, APP_DAT, and mmaped_data files shown in FIG. 1.

In FIG. 4, it is assumed that all of the wrapper image, the new middle difference, the old middle image, and the application data file 31 for migration are copied and stored in a storage device managed by the application image management unit 10. However, the middle image mounting destination 11 and the application data file mounting destination 12 themselves may represent paths of the images and files managed by the middle image management unit 30. In this case, the wrapper image, the new middle difference, the old middle image, and the application data file 31 for migration remain in the middle image management unit 30. Then, they are directly read from the middle image management unit 30 according to the processing in Steps S33 and S34 in the application image management unit 10.

The middle image management unit 30 determines whether the operation of the old middle image is necessary for the compatibility processing to be described later and the rollback to the old middle image. The rollback is processed when the application image management unit 10 performs processing of deleting the new version of the middle added in the system as a migration destination. However, when the control system is stably operated and the rollback becomes unnecessary, the old middle image may be updated by overwriting with a new middle image that is a new version. When the old middle image is updated by overwriting, the recording capacity of the recording device that stores the old middle image can be reduced.

Next, an operation example of the application image management unit 10 shown on the right side of FIG. 4 will be described.

First, the application image management unit 10 confirms an activation mode of the control system with reference to an activation mode management table T2 (S31).

The activation mode management table T2 has items: type; and mode. In the type item, a type of the activation mode of the control system is stored. Examples of the type of the activation mode include an image update mode and a normal operation mode. In the mode item, a word indicating the activation mode of the control system is stored. The word corresponding to the image update is “UPDATE”, and the word corresponding to the normal operation is “NORM”. When the user starts up a new version of the control system for the first time, “UPDATE” indicating the image update mode is selected. Thereafter, when the control system is in the normal operation, “NORM” indicating the normal operation mode is selected.

When determining that the activation mode is “UPDATE” related to the image update (S32), the application image management unit 10 mounts, in the middle image mounting destination 11, a new middle image set in the mounting point managed by the mounting point management table T1 (S33).

Next, the application image management unit 10 copies the application data file 31 for migration to the application data file mounting destination 12 set in the mounting point managed by the mounting point management table T1 (S34).

Next, the application image management unit 10 activates the mounted middle image to start up the control system. By start-up of the control system, the file system configuration management unit 20 (abbreviated as “configuration management unit” in the drawing) intervenes in the start-up processing (S35). The intervention processing of the file system configuration management unit 20 will be described later.

Next, the application image management unit 10 starts application processing, and the file system configuration management unit 20 performs compatibility processing (S36). The application image management unit 10 stores a system image (a configuration software stack representing a file configuration) in a control system software stack image 13 (S37) when the control system is terminated.

As described above, when the activation mode is the image update operation, the application image management unit 10 mounts the middle image created by the middle image management unit 30 and the application data file for migration picked up from the application environment by the middle image management unit 30 in the designated mounting destination. The application image management unit 10 stores a system image including the middle image subjected to the compatibility processing by the file system configuration management unit 20 in a storage unit (nonvolatile storage 47 or the like to be described later shown in FIG. 16) by start-up of the control system.

After the image update is performed for the control system, the control system is normally operated. Therefore, when determining that the activation mode is “NORM” related to the normal operation in Step S31 (S38), the application image management unit 10 conducts activation from the system image stored in the control system software stack image 13 (S39). When the activation mode is “NORM” related to the normal operation, the application image management unit 10 does not need to perform the processing (Steps S33 to S37) for the image update operation again. Therefore, when the activation mode is the normal operation, the application image management unit 10 constitutes the file system on the basis of the system image read from the storage unit.

FIG. 5 is a diagram showing a processing example of the middle image management unit 30 and a software stack of files.

The middle image management unit 30 shown in FIG. 5 creates an old version of a migration source middle image that is used in the control system as a migration source, a difference between the migration source middle image and a new version of a migration destination middle image that is used in the control system as a migration destination, and a wrapper file that ensures operation compatibility between the middle image of the control system as a migration destination and the application, and acquires a data file for migration that is used in the application environment. The compatibility processing unit 23 opens the wrapper file and loads the EXE file into the merge layer.

Examples of the images in using the old middle image are shown on the left side of FIG. 5. For example, targets to be migrated to the new control system are an application data image, an application image, a function extension module, and an old config image, and these are collectively referred to as an old middle image. The application data image corresponds to APP_DAT and mmaped_data shown in the upper right of FIG. 5. The application image is a file in a binary format, and corresponds to DLL and EXE, for example. The function extension module corresponds to DLL_EXT. The old config image corresponds to a config file.

The middle image management unit 30 mounts the old middle image in the old middle (lower-level layer) of the lower layer shown in the upper right of FIG. 5 (S41). The old middle image mounted in the lower-level layer is, for example, config, DLL, and EXE files.

Next, when the new middle image is installed, the middle image management unit 30 creates, in the lower layer, an upper-level layer in which the new version of the middle image can be stored (S42). In the upper-level layer, config_new, DLL_NEW, and EXE_NEW files, which are installing components of the new version of the middle image, are stored as a new version.

Next, the middle image management unit 30 creates a new middle difference that is a difference between the old middle image of the lower-level layer and the new middle image of the upper-level layer (S43). Next, the middle image management unit 30 automatically creates an old version compatibility wrapper (hereinafter, referred to as a wrapper image) on the basis of the new middle difference (S44). For example, even when the names of DLLs are the same, the parameters used in the old and new DLLs may be different. The middle image management unit 30 creates a wrapper image by adjusting the API input/output format with thimble analysis, for example. The upper right of FIG. 5 shows that the wrapper image is created from the difference between the upper-level layer and the lower-level layer of the lower layer and is created above the upper-level layer.

Next, the middle image management unit 30 extracts the middle image from the lower layer, and sets the middle image in the mounting point of the middle image mounting destination 11 (S45). Thereafter, the application image management unit 10 mounts the middle image (S46) as described with reference to Step S33 in FIG. 4. As shown in the upper right of FIG. 5, for example, in the lower layer, old middle images (config, DLL, and EXE) of the lower-level layer, middle (new middle differences config_new, DLL_NEW, and EXE_NEW) of the upper-level layer, and a wrapper image above them are mounted. This processing corresponds to the processing in Step S23A in FIG. 4.

It is necessary for the middle image management unit 30 to secure compatibility of a module for function extension on the application side. Therefore, the middle image management unit 30 can replace the middle image set in the mounting point of the middle image mounting destination 11 according to the middle version (S47).

Furthermore, when the control system after migration is stably operated, the old middle image becomes unnecessary. In this case, the middle image management unit 30 can also rebase the middle image set in the mounting point to the new middle image by application update or the like (S48). This processing has been described with reference to Step S23B in FIG. 4. In this case, the rebased middle image includes the wrapper image and the new middle image, and the old middle image is deleted.

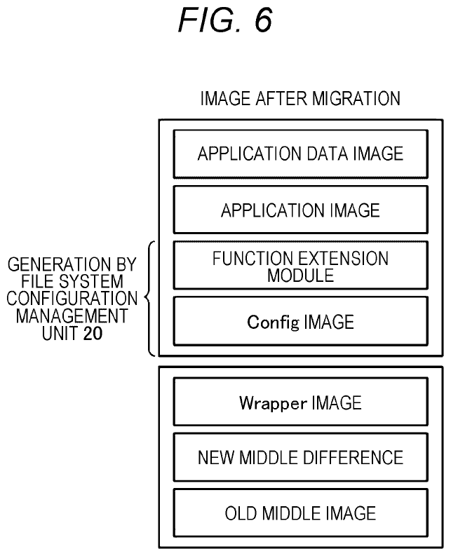

FIG. 6 is a diagram showing an example of a final image after processing by the application image management unit 10.

The image after migration includes a newly created wrapper image and a new middle difference, in addition to the application data image, the application image, the function extension module, the config image, and the old middle image that are targets to be migrated shown on the left side of FIG. 5. Since DLL_EXT and config images corresponding to the function extension module may require the compatibility processing, the file system configuration management unit 20 intervenes in Step S35 in FIG. 4 for generation.

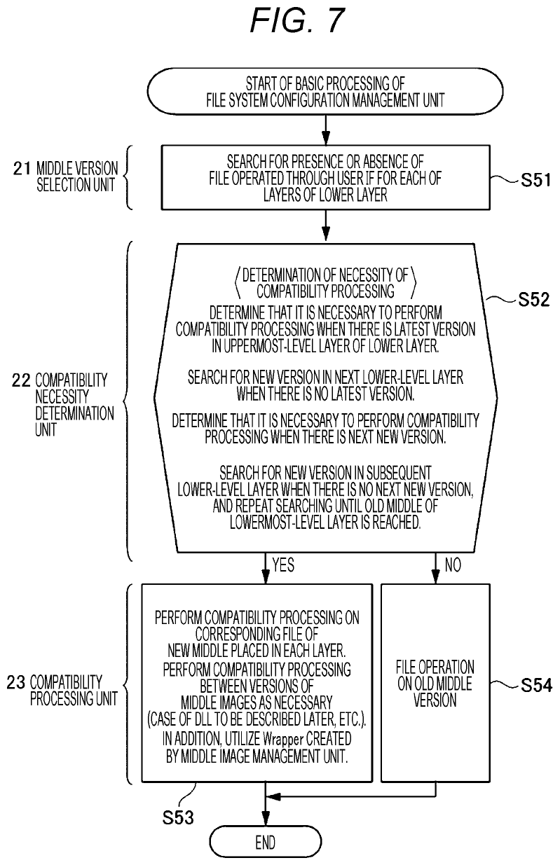

Next, an example of processing of the functional units of the file system configuration management unit 20 will be described with reference to FIG. 7 and subsequent drawings.

FIG. 7 is a flowchart showing an example of basic processing performed by the functional units of the file system configuration management unit 20 when the control system is started up. Here, common processing for the config and EXE files will be described.

First, the middle version selection unit 21 searches for the presence or absence of a file operated through the user IF for each of the layers of the lower layer managed by the middle image management unit 30 (S51).

Next, the compatibility necessity determination unit 22 determines whether the compatibility processing is necessary for the file searched by the middle version selection unit 21 (S52). When there is a latest version of a file in the uppermost-level layer of the lower layer, the compatibility necessity determination unit 22 determines that it is necessary to perform the compatibility processing. On the other hand, when there is no file in the uppermost-level layer, the middle version selection unit 21 searches for a new version of a file in the next lower-level layer. When there is a new version of a file in the next lower-level layer, the compatibility necessity determination unit 22 determines that it is necessary to perform the compatibility processing.

However, when there is no new version of a file in the next lower-level layer, the middle version selection unit 21 searches for a file in the subsequent lower-level layer. This searching is repeated until the file of the old middle image of the lowermost-level layer is reached. When there is a new version of a file in any lower-level layer, the compatibility necessity determination unit 22 determines that it is necessary to handle the new version.

When there is a file in any layer (YES in S52), the compatibility processing unit 23 performs the compatibility processing on the corresponding file of the new middle image placed in each layer. Here, the compatibility processing unit 23 utilizes the wrapper image as necessary in the compatibility processing of the middle image between the versions. The compatibility processing of the middle image between the versions will be described later, for example, as processing for DLL (S53).

When there is no new version of a file in the upper-level layer in Step S52 (NO in S52), the compatibility processing unit 23 performs a file operation on the middle image of the old middle version present in the lowermost-level layer (S54), and terminates the processing.

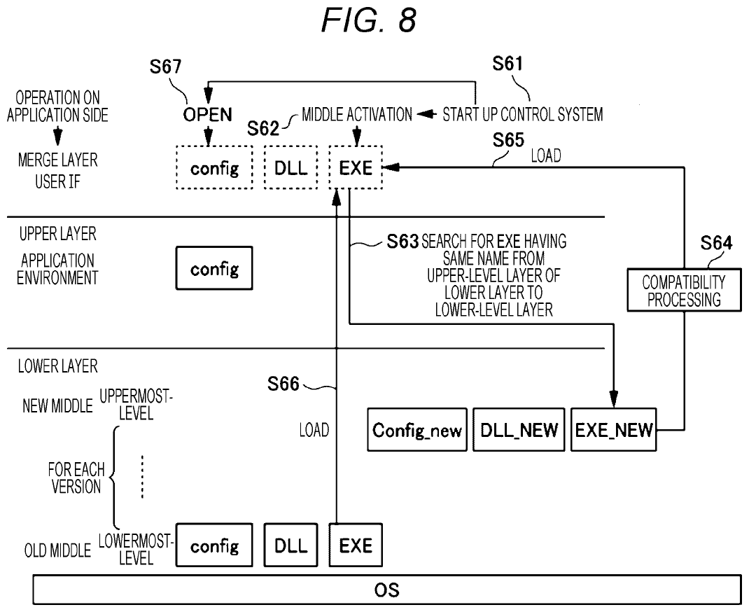

FIG. 8 is a diagram showing an example of a software stack when the control system is started up. Pieces of processing common to those in FIG. 7 are denoted by the same step numbers. In FIG. 8, processing for the EXE and EXE_NEW files will be described.

When the user starts up the control system (S61), middle image activation processing is started (S62). The middle image is activated by executing the EXE file. Therefore, the middle version selection unit 21 searches for an EXE file having the same name as the EXE file executed when the middle image is activated through the middle image management unit 30. This searching is performed from the upper-level layer to the lower-level layer of the lower layer (S63). This processing corresponds to the processing in Step S51 in FIG. 7.

The basic processing of the file system configuration management unit 20 is to confirm whether there is a file operated in the user IF layer on each of the layers of the lower layer for each version, and to determine whether the compatibility processing is necessary. Therefore, the file system configuration management unit 20 repeats the processing of confirming the presence of the EXE file from the uppermost-level layer to the lowermost-level layer, and performs the compatibility processing corresponding to the version of the layer in which the presence of the EXE file has been confirmed. When the middle version selection unit 21 can confirm that there is the EXE_NEW file that is the latest version of the middle in the uppermost-level layer, the compatibility necessity determination unit 22 determines whether the compatibility of the EXE_NEW file is necessary. This processing corresponds to the processing in Step S52 in FIG. 7.

When the compatibility necessity determination unit 22 determines that the compatibility processing is necessary, the compatibility processing unit 23 performs the compatibility processing on the EXE_NEW file (S64). This processing corresponds to the processing in Step S53 in FIG. 7. After that, the compatibility processing unit 23 loads the EXE_NEW file after the compatibility processing into the merge layer (S65). The EXE_NEW file after the compatibility processing can be operated through the user IF.

Meanwhile, when the EXE file is not in the upper-level layer of the lower layer but is in the lowermost-level layer, the EXE file is an old version. For this reason, the compatibility processing unit 23 does not perform the compatibility processing on the EXE file existing in the lowermost-level layer. The compatibility processing unit 23 loads the EXE file of the lowermost-level layer into the merge layer (S66). This processing corresponds to the processing in Step S54 in FIG. 7.

When the EXE file loaded into the merge layer is executed, opening of the config file is started in the merge layer (S67). Processing of the config file will be described later.

As described above, the file system configuration management unit 20 confirms whether the file operated through the user IF is on each of the layers of the lower layer. Then, the file system configuration management unit 20 can automatically select the middle version of the file operated by the user through the user IF, determine whether the compatibility processing is necessary, perform the compatibility processing on the file that needs to be handled, and load the file into the merge layer.

### <Compatibility Processing of Setting of Config File>

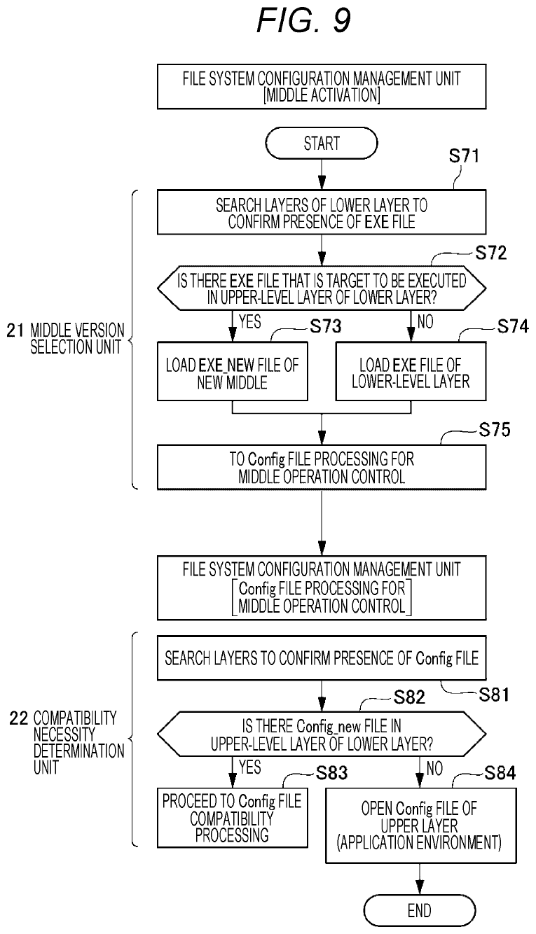

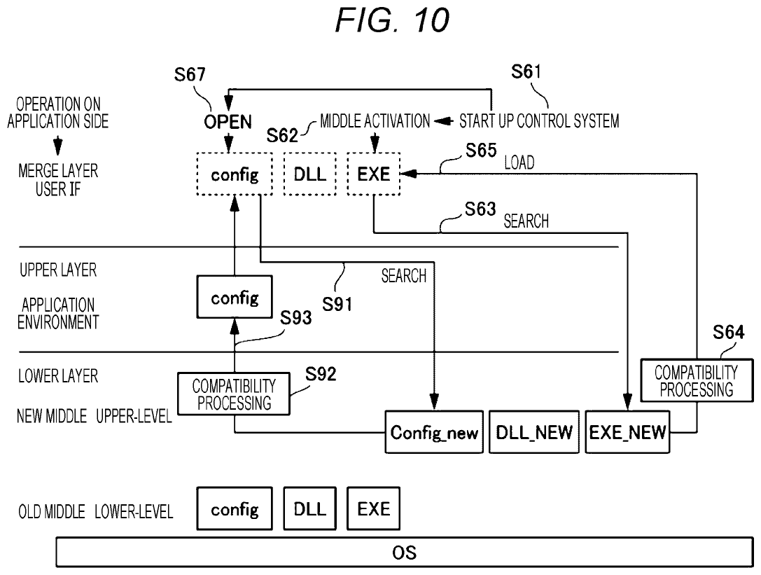

Next, compatibility processing of setting of the config file will be described with reference to FIGS. 9 and 10. Here, processing for a case where a config_new file does not exist in the upper layer but exists in the lower layer will be described.

FIG. 9 is a flowchart showing an example of processing of the middle version selection unit 21 and the compatibility necessity determination unit 22 in the compatibility processing of the setting of the config file. The compatibility processing of the setting of the config file is processing of ensuring the compatibility of the user IF on the application side with the conventional function other than the new function of the new middle image. The Config file that is a target in the processing is used to control the operation of the middle image. In the processing to be described below, the middle version selection unit 21 searches the middle layer for the EXE file activated by start-up of the control system, loads the EXE file subjected to the compatibility processing into the merge layer in which the user IF is constituted, then searches the middle layer for the config file of the application, and opens the config file subjected to the compatibility processing in the merge layer.

First, an example of the middle image activation processing performed by the middle version selection unit 21 will be described.

When the control system is started up, the middle version selection unit 21 searches the layers of the lower layer to confirm the presence of the EXE file (S71). In this search processing, the middle version selection unit 21 determines whether the EXE file that is a target to be executed exists as a new middle image in order from the upper-level layer to the lower-level layer of the lower layer (S72).

When it is determined that there is the EXE file that is a target to be executed in the upper-level layer of the lower layer (YES in S72), this EXE file exists in the upper-level layer as an EXE_NEW file of the new middle image. Therefore, the middle version selection unit 21 loads the EXE_NEW file of the new middle image into the merge layer (S73). As described with reference to FIGS. 7 and 8, the EXE_NEW file is loaded into the merge layer after undergoing the determination of whether compatibility is necessary and being subjected to the compatibility processing.

In Step S72, when it is determined that the EXE file that is a target to be executed does not exist as a new middle image in the upper-level layer of the lower layer (NO in S72), the middle version selection unit 21 loads the EXE file present in the lower-level layer into the merge layer (S74).

After Step S73 or S74, the EXE file loaded into the merge layer is executed. As described in Step S67 in FIG. 8, when the EXE file is executed, opening of the config file is started. Therefore, the file system configuration management unit 20 proceeds to config file processing for middle operation control (S75).

Next, an example of the config file processing for middle operation control by the compatibility necessity determination unit 22 will be described.

The compatibility necessity determination unit 22 needs to confirm the presence of the config file. Therefore, the compatibility necessity determination unit 22 searches for the config_new file in the layers of the lower layer (S81). In this search processing, the compatibility necessity determination unit 22 determines whether the config_new file exists in the upper-level layer of the lower layer (S82).

The config file is a file set on the user side through the user IF. Therefore, the setting content of the config_new file present in the upper-level layer of the lower layer needs to be compatible with the setting content of the config file of the old middle image. The config_new file that is subjected to the compatibility processing is used to control the new version of the EXE_NEW file in the new middle image.

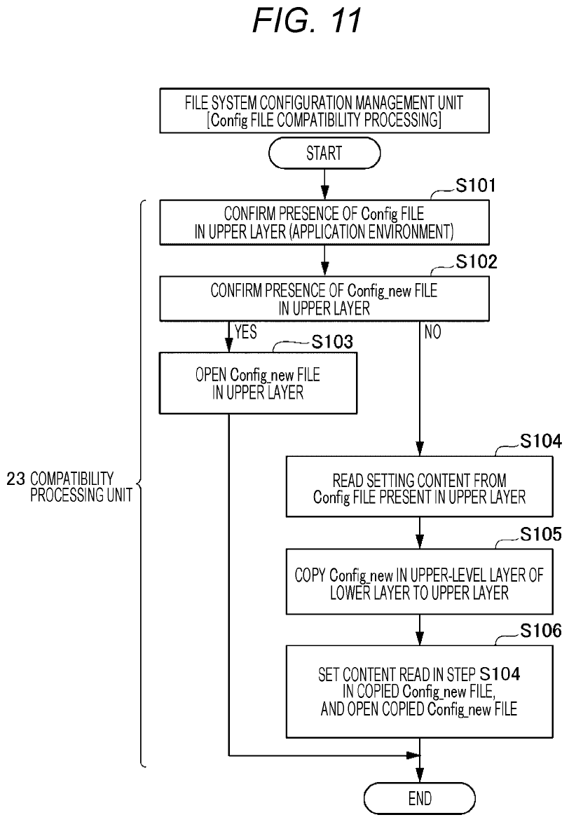

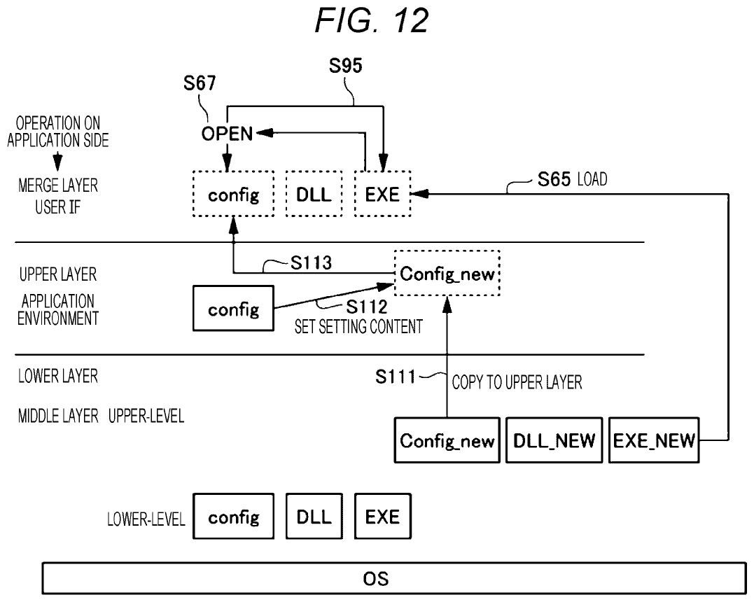

When there is the config_new file in the upper-level layer of the lower layer (YES in S82), the compatibility necessity determination unit 22 proceeds to config file compatibility processing to be described later with reference to FIGS. 11 and 12 (S83).

On the other hand, when the config_new file does not exist in the upper-level layer of the lower layer (NO in S82), the config_new file exists in the upper layer (application environment). Therefore, the compatibility necessity determination unit 22 opens the config file present in the upper layer (S84), and terminates the processing.

FIG. 10 is a diagram showing an example of a software stack in the compatibility processing of the setting content of the config file.

As described with reference to FIG. 8, when the control system is started up, and then opening of the config file is started after the processing in Steps S61 to S65 (S67), the middle version selection unit 21 searches the lower layer for the config file (S91). This processing corresponds to the processing in Step S81 in FIG. 9.

When it is found that a new version of the config_new file corresponding to the opened config file exists in the upper-level layer of the lower layer, the compatibility necessity determination unit 22 determines whether the compatibility of the config_new file is necessary. When the compatibility necessity determination unit 22 determines that the compatibility processing is necessary, the compatibility processing unit 23 performs the compatibility processing on the config_new file (S92), and mounts the config_new file after the compatibility processing as the config file in the application environment (S93). The config file mounted in the application environment is opened in the merge layer.

As described with reference to FIG. 9, when the config_new file does not exist in the upper-level layer of the lower layer, the config file existing in the application environment of the upper layer is opened. The determination of whether compatibility is necessary for the config file and the compatibility processing are not performed.

### <Example of Compatibility Processing of Config File>

Next, compatibility processing of the config file will be described with reference to FIGS. 11 and 12. Here, processing for a case where a config file exists in the upper layer (application environment), varying depending on whether the config_new file exists in the upper layer, will be described.

FIG. 11 is a flowchart showing an example of compatibility processing of the config file performed by the compatibility processing unit 23. In the processing to be described below, when the config_new file exists in the application environment, the compatibility processing unit 23 opens the config_new file. On the other hand, when the config_new file does not exist in the application environment, the compatibility processing unit 23 reads the setting content from an old version of the config file existing in the application environment. Then, the compatibility processing unit 23 copies the config_new file existing in the upper-level layer of the middle layer to the application environment, sets the setting content in the copied config_new file, and opens the config_new file in the merge layer in which the user IF is constituted.

First, the compatibility processing unit 23 confirms whether the config file exists in the upper layer (S101). Next, the compatibility processing unit 23 confirms whether the config_new file exists in the upper layer (S102).

When there is the config_new file in the upper layer (YES in S102), the compatibility processing unit 23 opens the config_new file in the upper layer (S103), and terminates the processing.

On the other hand, when there is no config_new file in the upper layer (NO in S102), the compatibility processing unit 23 reads the setting content from the config file present in the upper layer (S104). Next, the compatibility processing unit 23 copies the config_new file present in the upper-level layer of the lower layer to the upper layer (S105).

Next, the compatibility processing unit 23 sets the setting content of the config file read in Step S104 in the copied config_new file. In the copied config_new file, the setting content of matching items among a plurality of items of the config file read in Step S104 are set. Thereafter, the copied config_new file is opened, and the processing is terminated (S106).

FIG. 12 is a diagram showing an example of a software stack in the compatibility processing of the config file.

Here, as described with reference to FIGS. 9 and 10, the compatibility processing unit 23 performs the compatibility processing of the EXE_NEW file present in the upper-level layer of the middle to load the EXE_NEW file as an EXE file into the merge layer (S65).

First, since the EXE_NEW file loaded into the merge layer is executed and the config file is opened, the middle version selection unit 21 searches for a new version of the config_new file. Therefore, the middle version selection unit 21 searches the layers of the upper layer and the lower layer for the config_new file. This processing corresponds to the processing in Steps S101 and S102 in FIG. 11.

When there is the config_new file in the upper layer, the compatibility processing unit 23 opens the config_new file present in the upper layer, and terminates the processing. This processing corresponds to the processing in Step S103 in FIG. 11.

On the other hand, when the config_new file does not exist in the upper layer, the middle version selection unit 21 determines whether the config_new file exists in the upper-level layer of the lower layer. When there is the config_new file in the upper-level layer of the lower layer, the compatibility necessity determination unit 22 reads the config file of the upper layer. Next, the compatibility processing unit 23 copies the config_new file present in the upper-level layer of the lower layer to the upper layer (S111). Next, the compatibility processing unit 23 sets the setting content of the previously read config file in the copied config_new file (S112). The config_new file in which the setting content is set is opened in the merge layer (S113). The processing so far corresponds to the processing in Steps S104 to S106 shown in FIG. 11.

In this manner, the setting content of the existing config file is automatically set in the copied config_new file. Therefore, the user does not need to confirm the setting content of the existing config file, select the necessary content, and work for setting the content in the config_new file.

### <Example of DLL Compatibility Processing>

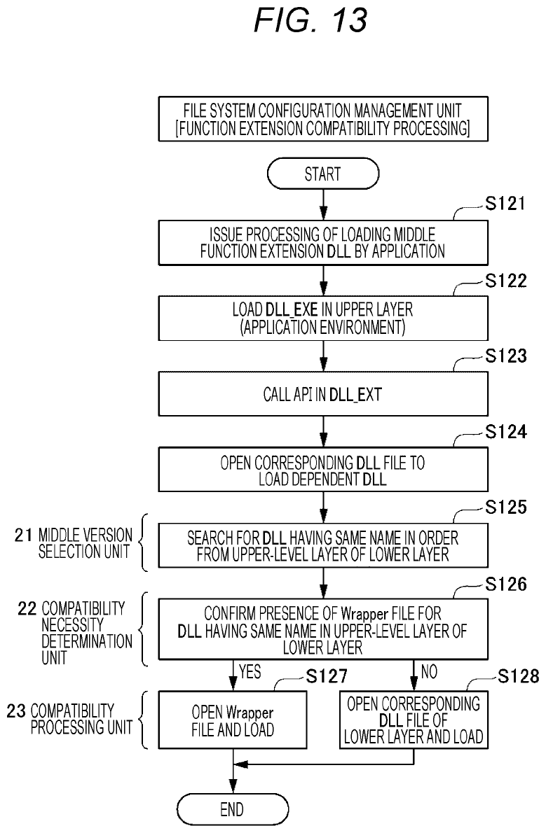

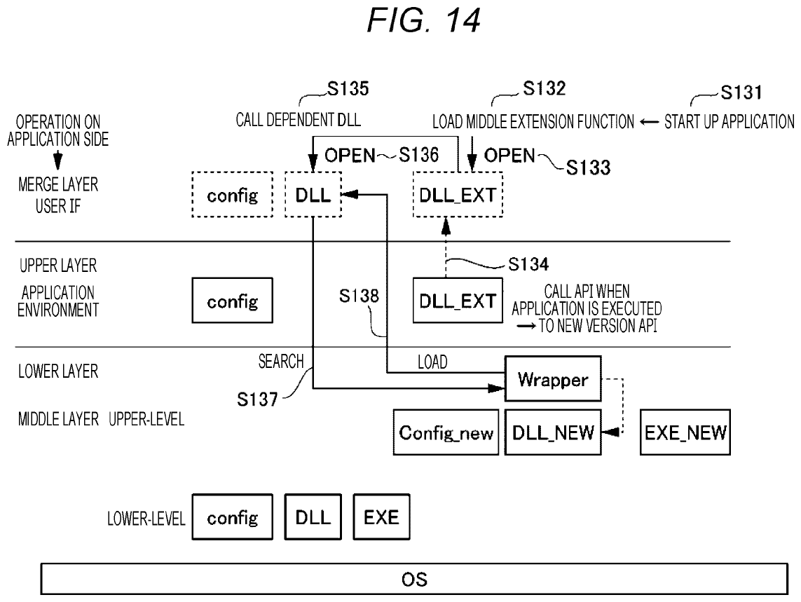

Next, an example of DLL compatibility processing will be described with reference to FIGS. 13 and 14. The DLL compatibility processing is processing in which the file system configuration management unit 20 loads a wrapper file instead of a DLL_NEW file when confirming the presence of the wrapper in the lower layer.

FIG. 13 is a flowchart showing an example of function extension compatibility processing performed by the file system configuration management unit 20.

First, when the application is started up by an operation on the application-side, the file system configuration management unit 20 issues processing of loading a middle function extension DLL file (S121). In the following description, the middle function extension DLL file is referred to as a “DLL_EXT file”. The DLL_EXT file extends the function of a conventional DLL file. Next, the file system configuration management unit 20 loads the DLL_EXT file present in the upper layer (application environment) into the merge layer (S122).

Next, the file system configuration management unit 20 calls API in the DLL_EXT file (S123). By the API call, the DLL_EXT file starts dependent DLL file loading processing for calling a DLL (referred to as a “dependent DLL file”) on which the DLL_EXT file depends. Then, in order for the DLL_EXT file to load the dependent DLL file, opening of the DLL file corresponding to the dependent DLL file is started (S124).

Next, the middle version selection unit 21 searches for a DLL file having the same name as the DLL file to be opened in Step S124 in order from the upper-level layer of the lower layer (S125). The compatibility necessity determination unit 22 confirms whether there is a wrapper file for the DLL file having the same name as the DLL file opened in Step S124 in the upper-level layer of the lower layer (S126).

When there is a wrapper file in the upper-level layer of the lower layer (YES in S126), the compatibility processing unit 23 opens the wrapper file, loads the DLL file of the wrapper file into the merge layer (S127), and terminates the processing. On the other hand, when no wrapper file exists (NO in S126), the compatibility processing unit 23 opens the DLL file existing in the lower layer and corresponding to the same name as the DLL file opened in Step S124, loads the DLL file into the merge layer (S128), and terminates the processing.

FIG. 14 is a diagram showing an example of a software stack in the DLL compatibility processing.

When the application is started up (S131), processing of loading a function extension DLL for middle function extension is issued (S132), and when a DLL_EXT file that is the function extension DLL present in the upper layer is opened (S133), the DLL_EXT file can be operated in the merge layer (S134). The DLL_EXT file calls the dependent DLL file (S135), and opens the dependent DLL file (S136).

The DLL file corresponding to the dependent DLL file exists in the lower-level layer of the lower layer, and the DLL_NEW file exists in the upper-level layer. Furthermore, a wrapper file for DLL created on the basis of the DLL_NEW file is present in a layer above the DLL_NEW file.

When the DLL file is opened in Step S136, the DLL file is searched for in the lower layer (S137). In this case, since the wrapper file for DLL in the lower layer is searched for preferentially, the wrapper file for DLL is opened, and the DLL file included in the wrapper file for DLL is loaded into the merge layer (S138). In this way, the DLL_NEW file can be used in the user IF.

### [Modification Example of File Management System]

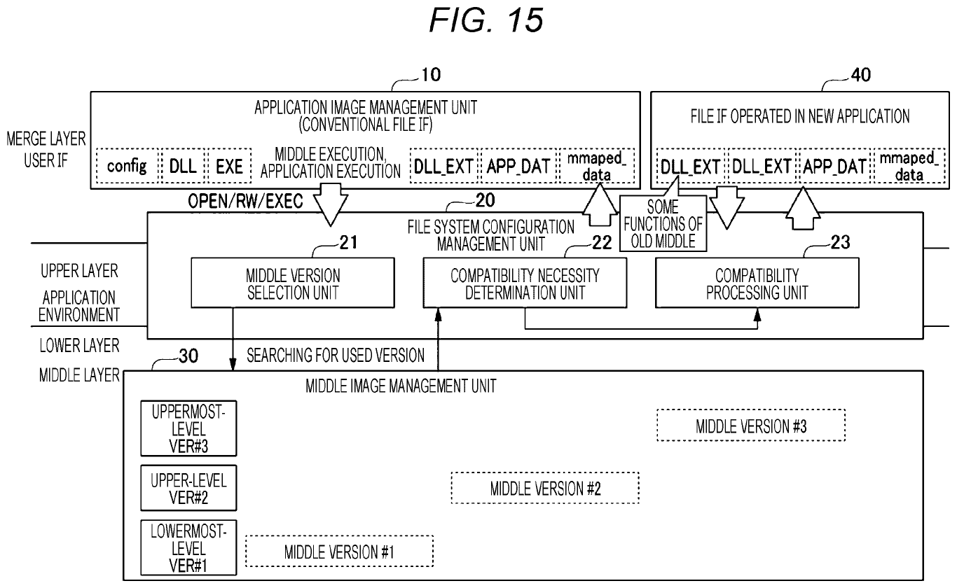

FIG. 15 is a schematic diagram showing an outline of operation examples of the functional units by the file management system 1 in the installation and the operation of a new application, and an example of a software stack. FIG. 15 is a diagram showing that the file management system 1 according to the present embodiment can be used even in a new file IF operated by the new application.

In the embodiment described with reference to FIG. 1, when a file included in the old application environment is copied to the new application environment, compatibility with a new version of a file is handled, so that the conventional user IF can be continuously used even in the new application environment. Here, other than the files to be ported to the new application environment, files of the middle version necessary for the execution of the new application that is operated by a computing machine as a porting destination are selected.

Since the new application utilizes the function of the new middle image, the middle version selection unit 21 selects the new version of the middle image present in the uppermost-level layer of the lower layer. In addition, a user IF 40 used in the operation of the new application is partially different from the conventional user IF. In the user IF 40, for example, DLL_EXT, APP_DAT, and mmaped_data of the middle version #2 managed as the upper-level VER #2 are operated by the middle image management unit 30.

However, the file management system 1 also enables the new application to use the function of the old version that is not implemented in the middle image of the new version. For example, the DLL_EXT file of the middle version #3 managed as the uppermost-level VER #3 uses some functions of the old middle image. Therefore, the user IF 40 of the new application can also use the DLL_EXT file of the middle version #3 used in the old application.

### <Hardware Configuration Example of Computing Machine>

Next, a hardware configuration of a computing machine 40 constituting the file management system 1 will be described.

FIG. 16 is a block diagram showing a hardware configuration example of the computing machine 40. The computing machine 40 is an example of hardware used as a computer (server or personal computer (PC)) operable as the file management system 1 according to the present embodiment. In the file management system 1 according to the present embodiment, the computing machine 40 (computer) executes a program to constitute functional blocks, and the functional blocks cooperate to realize the file management methods shown in FIGS. 4, 5, 7, 9, 11, and 13.

The computing machine 40 includes a central processing unit (CPU) 41, a read only memory (ROM) 42, and a random access memory (RAM) 43 each connected to a bus 44. The computing machine 40 further includes a display device 45, an input device 46, a nonvolatile storage 47, and a network interface 48.

The CPU 41 reads a program code of software for realizing the functions according to the present embodiment from the ROM 42, loads the program code into the RAM 43, and executes the program code. Variables, parameters, and the like generated during arithmetic processing of the CPU 41 are temporarily written to the RAM 43, and these variables, parameters, and the like are appropriately read by the CPU 41.

The display device 45 is, for example, a liquid crystal display monitor, and displays a result of the processing performed by the computing machine 40 and the like to the user. As the input device 46, for example, a keyboard, a mouse, or the like is used, and the user can input predetermined operations and give instructions. The above-described application operation is performed while the user views the file displayed on the display device 45. In addition, the control system is migrated by the user operating a migration tool or the like displayed on the display device 45.

As the nonvolatile storage 47, for example, a hard disk drive (HDD), a solid state drive (SSD), a flexible disk, an optical disk, a magneto optical disk, a nonvolatile memory, or the like is used. In the nonvolatile storage 47, programs for causing the computing machine 40 to function are recorded in addition to the OS and various parameters. Programs, data, and the like necessary for the operation of the CPU 41 are recorded in the ROM 42 and the nonvolatile storage 47. For example, the nonvolatile storage 47 stores the application data file 31 for migration, the control system software stack image 13, and the like shown in FIG. 4. In addition, the nonvolatile storage 47 is also used as a mounting destination of the application data file for the middle image shown in FIG. 4. The ROM 42 and the nonvolatile storage 47 are used as an example of a non-transitory computer-readable storage medium storing programs to be executed by the computing machine 40.

For example, a network interface card (NIC) or the like is used as the network interface 48. The network interface 48 can transmit and receive various data between devices via a local area network (LAN), a dedicated line, or the like connected to a terminal of the NIC.

In the file management system 1 according to the embodiment described above, the middle image management unit 30 manages a plurality of versions of middle images. The middle image management unit 30 passes a new version of a middle image among the middle images searched by the middle version selection unit 21 to the compatibility necessity determination unit 22. Then, the compatibility necessity determination unit 22 determines whether compatibility is necessary according to the middle version of the middle image used in the control system as a migration destination, and the compatibility processing unit 23 performs the compatibility processing on the middle image requiring the compatibility processing. The middle image subjected to the compatibility processing can be used through the user IF. Therefore, it is possible to easily migrate the application environment (including application data such as setting of control tags) when the control system is migrated in association with a version upgrade of the control system.

In addition, the file management system 1 separates the upper layer (application environment) from the lower layer (middle layer) by constituting a software stack with a hierarchized middle image. The file management system 1 can generate and manage only a difference occurring due to changes in the application environment as a file that is easy to migrate, and migrate the file including the difference while ensuring compatibility even in the new version. Therefore, the user can perform the file operation while the user IF used in the control system as a migration destination is made to be the same as the conventional user IF. In addition, in the user IF, even after migration of the control system, the file is displayed in the same manner as before. Therefore, the user who uses the user IF is not aware of the difference in middle version.

In addition, the file management system 1 can operate the new middle image while maintaining compatibility between the setting file (config file) created in the old middle image and the DLL file for function extension.

In addition, even when the middle image is managed in a plurality of old and new versions, the compatibility processing is not for updating the middle image present in the lower layer. Therefore, when a failure occurs after the middle image after the compatibility processing is loaded into the merge layer, it is easy to immediately perform rollback for returning to the old version of the middle image.

The following two implementation forms are assumed for the file management system 1. In any of the following implementation forms, the file management system 1 can be realized without modifying the OS.

For example, event hook processing of the file system on the host OS may be used other than the start-up of the control system or the application. In this case, the lower layer search processing, the compatibility necessity determination processing, and the compatibility processing described above may be performed by hooking an event such as READ or WRITE.

In addition, when the file management system 1 is operated in a container, the file management system 1 may be managed by an image configuration management unit operated in the container. For example, the software stack described above may be applied to a container image used in the container.

Furthermore, in the file management system 1, for example, the files in the layers can also be managed using a hierarchical file system such as overlayfs, zfs, or btrfs used in Linux (registered trademark).

Note that the present invention is not limited to the above-described embodiments, and it goes without saying that various other application examples and modification examples can be taken without departing from the gist of the present invention described in the claims.

For example, in order to describe the present invention in an easy-to-understand manner, the system configuration is described in detail and specifically in the above-described embodiments, and is not necessarily limited to those including all the configurations described above. In addition, the addition of other configurations, deletion, or replacement can be performed on a part of the configuration of the present embodiment.

In addition, the control lines and the information lines indicate what is considered to be necessary for the description, and do not necessarily indicate all the control lines and the information lines on the product. In practice, it may be considered that almost all the configurations are connected to each other.

What is claimed is:

1. A file management system that manages a file system in which a user interface that is operated by an application of a control system is constituted, an application environment in which files operated through the user interface are managed is constituted, and a middle layer in which some of the files used in the application environment are managed for each version of the control system is constituted, the file management system comprising:
an application image management unit that manages an application image that is a set of the files used in the application;
a middle image management unit that manages a middle image that is a set of some of the files managed in the middle layer for each version; and
a file system configuration management unit that performs compatibility processing for using the middle image selected from the middle image management unit in the application environment, and places the middle image subjected to the compatibility processing in the application environment to make the middle image usable in the user interface.

2. The file management system according to claim 1,
wherein the file system configuration management unit determines whether compatibility processing is necessary for the middle image of the version selected from the middle image management unit, performs the compatibility processing on the middle image for which the compatibility processing is determined to be necessary, and causes the application image management unit to use the middle image subjected to the compatibility processing.

3. The file management system according to claim 2,
wherein, when an activation mode is an image update operation, the application image management unit mounts the middle image created by the middle image management unit and an application data file for migration picked up from the application environment by the middle image management unit in a designated mounting destination, stores a system image including the middle image subjected to the compatibility processing by the file system configuration management unit in a storage unit by start-up of the control system, and constitutes the file system on a basis of the system image read from the storage unit when the activation mode is a normal operation.

4. The file management system according to claim 3,
wherein the user interface ensures compatibility between a processing operation of the middle layer and the application environment used in the control system as a migration source and a processing operation of the middle layer and the application environment used in the control system as a migration destination.

5. The file management system according to claim 4,
wherein the middle image management unit manages the middle image for each version in a hierarchical structure, and
the file system configuration management unit has
a middle version selection unit that selects the middle image to be searched for from the middle image management unit in order of a latest version,
a compatibility necessity determination unit that determines whether compatibility processing is necessary for the middle image selected by the middle version selection unit, and
a compatibility processing unit that performs the compatibility processing on the middle image for which the compatibility processing is determined to be necessary.

6. The file management system according to claim 5,
wherein the middle version selection unit searches the middle layer for an execution file activated by start-up of the control system, loads the execution file subjected to the compatibility processing into a merge layer in which the user interface is constituted, then searches the middle layer for a setting file of the application, and opens the setting file subjected to the compatibility processing in the merge layer.

7. The file management system according to claim 5,
wherein, when a new version of a setting file exists in the application environment, the compatibility processing unit opens the new version of the setting file, and when a new version of a setting file does not exist in the application environment, the compatibility processing unit reads a setting content from an old version of the setting file existing in the application environment, copies a new version of the setting file existing in an upper-level layer of the middle layer to the application environment, sets the setting content in the copied new version of the setting file, and opens the new version of the setting file in a merge layer in which the user interface is constituted.

8. The file management system according to claim 6,
wherein the middle image management unit creates an old version of a migration source middle image that is used in the control system as a migration source, a difference between the migration source middle image and a new version of a migration destination middle image that is used in the control system as a migration destination, and a comprehensive file that ensures operation compatibility between the middle image of the control system as a migration destination and the application, and acquires a data file for migration that is used in the application environment, and
the compatibility processing unit opens the comprehensive file and loads the execution file into the merge layer.

9. The file management system according to claim 4,
wherein, when the middle image subjected to the compatibility processing has a defect, the file system configuration management unit acquires an old version of the middle image and performs rollback allowing using in the application image management unit.

10. A file management method that is performed by a file management system that manages a file system in which a user interface that is operated by an application of a control system is constituted, an application environment in which files operated through the user interface are managed is constituted, and a middle layer in which some of the files used in the application environment are managed for each version of the control system is constituted, the file management method comprising:
managing an application image that is a set of the files used in the application by an application image management unit;
managing a middle image that is a set of some of the files managed in the middle layer for each version by a middle image management unit; and
performing compatibility processing for using the middle image selected from the middle image management unit in the application environment, and placing the middle image subjected to the compatibility processing in the application environment to make the middle image usable in the user interface by a file system configuration management unit.
